(19) United States
(12) Patent Application Publication
(10) Pub. No.: US 2025/0296067 A1
(43) Pub. Date: Sep. 25, 2025

(54) INTERNAL REFLECTOR PHOTOREACTOR SYSTEM FOR CARBON DIOXIDE (CO2) CONVERSION

(71) Applicant: KING FAHD UNIVERSITY OF PETROLEUM AND MINERALS, Dhahran (SA)

(72) Inventors: Abdullah Salem Mohammed BAFAQEER, Dhahran (SA); Aniz Chennampilly UMMER, Dhahran (SA)

(73) Assignee: KING FAHD UNIVERSITY OF PETROLEUM AND MINERALS, Dhahran (SA)

(21) Appl. No.: 18/620,341

(22) Filed: Mar. 28, 2024

(30) Foreign Application Priority Data
Mar. 19, 2024 (SA) 1020241436

(51) Int. Cl. B01J 19/12; B01J 19/00; B01J 19/02; B01J 27/24; B01J 35/39; B01J 35/54; B01J 37/02; B01J 37/08

(52) U.S. Cl. CPC B01J 19/127; B01J 19/0013; B01J 19/02; B01J 27/24; B01J 35/39; B01J 35/54; B01J 37/0215; B01J 37/084; B01J 2219/00051; B01J 2219/00162; B01J 2219/0286; B01J 2219/0881; B01J 2219/1203; B01J 2219/1943; B01J 2219/32203; B01J 2219/32433

(57) ABSTRACT

An internal reflector photoreactor system includes a stainless-steel cylindrical vessel having a window on a top face. The stainless-steel cylindrical vessel has a reflector inside the vessel on a bottom surface orientated towards the top face and the stainless-steel cylindrical vessel has a mesh bisecting the stainless-steel cylindrical vessel on a horizontal plane and the mesh is coated with a graphitic carbon nitride photocatalyst. Further, the internal reflector photoreactor system includes a light source and the light source is located above the stainless-steel cylindrical vessel.

### CROSS REFERENCE TO RELATED APPLICATION

The present disclosure claims the benefit of Saudi Patent Application No. 1020241436 filed on Mar. 19, 2024, with the Saudi Authority for Intellectual Property Office, which is incorporated herein by reference in its entirety.

### BACKGROUND

### Technical Field

The present disclosure is directed towards an internally reflected photoreactor system and, more particularly, an internally reflected photoreactor system for carbon dioxide (CO₂) conversion to green fuels.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

The rise in levels of atmospheric carbon dioxide (CO₂) is considered one of the main contributors to the greenhouse effect and has attracted attention in the past few decades [X. Wang, J. He, X. Chen, B. Ma, M. Zhu, Metal halide perovskites for photocatalytic CO₂ reduction: An overview and prospects, Coordination Chemistry Reviews, 482 (2023) 215076]. Several approaches have been employed to mitigate CO₂ effects, such as conversion of CO₂ emission at the source, CO₂ capture and storage, and reutilization of CO₂ by reduction to useful chemicals and fuels; [D. Zhu, S. Peng, S. Zhao, M. Wei, B. Bai, Comprehensive review of sealant materials for leakage remediation technology in geological CO₂ capture and storage process, Energy & Fuels, 2021, 35, 6, 4711-4742] however, these technologies have disadvantages that including high electrical voltage and high-temperature requirements to break the stable CO₂ molecule, unsustainability, limitations of raw materials, and high cost of operation.

More recently, photocatalytic conversion of CO₂ using light irradiation has been employed due to the fact that it is carried out at normal pressure and low temperature [J.-Y. Tang, C.-C. Er, X. Y. Kong, B.-J. Ng, Y.-H. Chew, L.-L. Tan, A. R. Mohamed, S.-P. Chai, Two-dimensional interface engineering of g-C₃N₄/g-C₃N₄ nanohybrid: Synergy between isotype and p-n heterojunctions for highly efficient photocatalytic CO₂ reduction, Chemical Engineering, 466, 2023, 143287]. The CO₂ reduction by photoreaction technology may help to fulfill the current energy demands and may contribute to solving environmental problems; however, the efficiency of photocatalytic activity and selectivity is lower for the reduction of CO₂ compared to other renewable energy chemical reactions. The performance of the photocatalytic process may be improved by the design of photoreactors [A. Bratovčić, V. Tomašić, Design and Development of Photocatalytic Systems for Reduction of CO₂ into Valuable Chemicals and Fuels, Processes, 2023, 11(5), 1433].

There has been a gradual development in the design of photoreactors. The reactors employed for photocatalytic processes include slurry photoreactors, membrane photoreactors, and fixed-bed photoreactors. The slurry photoreactors are the most frequently utilized photoreactor and involve a three-phase system where the catalyst bed is in a fluidized form and is agitated to increase mass transfer between catalyst and reactants, thus providing a high surface area to be illuminated. Membrane photoreactors consist of two chambers or towers and are separated by a membrane [M. Baniamer, A. Aroujalian, S. Sharifnia, Photocatalytic membrane reactor for simultaneous separation and photoreduction of CO₂ to methanol, International Journal of Energy Research, 2021, 45(2), 2353-2366]. Reactions in membrane photoreactors take place in a controlled manner and prevents backward reactions from occurring, but the limited charge and mass transfer is a limitation of membrane photoreactors. In fixed-bed photoreactors, photocatalysts are immobilized (fixed) on supporting materials such as plates, beads, fibers, optical fibers, monoliths, and the like. The fixed photocatalysts are placed inside the photoreactor around the light or directly on the photoreactor wall [A. A. Khan, M. Tahir, Recent advancements in engineering approach towards design of photo-reactors for selective photocatalytic CO₂ reduction to renewable fuels, Journal of CO₂ Utilization 29, 2019, 205-239]. Fixed-bed photoreactors have high gas output and do not require separation of catalyst, light distribution can be a limitation.

Although several photocatalysts and photoreactor systems have been developed in the past, each of them suffers from certain drawbacks that hinder their widespread adoption. Accordingly, an objective of the present disclosure is to develop an efficient photoreactor system, with high yield rates for CO₂ conversion to green fuels.

### SUMMARY

In an exemplary embodiment, an internal reflector photoreactor system is disclosed. The internal reflector photoreactor system includes a stainless-steel cylindrical vessel. The stainless-steel cylindrical vessel has a window on a top face. The stainless-steel cylindrical vessel has a reflector inside the stainless steel cylindrical vessel on a bottom face orientated towards the top face and the stainless-steel cylindrical vessel has a mesh bisecting the stainless-steel cylindrical vessel on a horizontal plane. The mesh is coated with a graphitic carbon nitride photocatalyst. Further, the internal reflector photoreactor system includes a light source and the light source is located above the stainless-steel cylindrical vessel.

In some embodiments, the window is a quartz window.

In some embodiments, the reflector is a planar reflector.

In some embodiments, in addition to the bottom face, one or more internal surfaces of the stainless-steel cylindrical vessel are reflective.

In some embodiments, a vertical surface of the stainless-steel cylindrical vessel has one or more windows.

In some embodiments, the mesh bisecting the stainless-steel cylindrical vessel on the horizontal plane is at an equal distance from an internal surface of the top face and the bottom surface.

In some embodiments, the graphitic carbon nitride photocatalyst is in the form of two-dimensional aggregated nanosheets.

In some embodiments, the aggregated nanosheets have an irregular shape with ridges and valleys. The ridges and valleys have a length of 50 to 1000 nanometers (nm).

In another exemplary embodiment, a method of making the graphitic carbon nitride photocatalyst is described. The method includes heating melamine to 500 to 600° C. for 1 to 3 hours at a rate of 2 degrees Celsius per minute (° C./min) to 10° C./min, followed by cooling to form the graphitic carbon nitride photocatalyst.

In some embodiments, the mesh is coated with the graphitic carbon nitride photocatalyst by a process including mixing the graphitic carbon nitride photocatalyst with alcohol and a protic solvent for 18 hours to 30 hours to form a sol. The process further includes immersing the mesh in the sol for a time sufficient to coat the mesh and drying the sol-coated mesh. Furthermore, repeating the immersing and drying for a number of cycles sufficient to form a catalyst-supported mesh and heating the catalyst-supported mesh at a first temperature of 60 to 100° C. for 10 to 14 hours. Moreover, the process includes increasing the first temperature at a rate of 2 to 10° C./min to a second temperature of 450 to 550° C. and holding at the second temperature for 4 to 6 hours.

In some embodiments, the mesh is coated with 0.005 to 0.1 grams of graphitic carbon nitride photocatalyst per square centimeter of mesh.

In some embodiments, the stainless-steel cylindrical vessel has a pressure adjustor.

In some embodiments, the stainless-steel cylindrical vessel has a temperature adjustor.

In some embodiments, the stainless-steel cylindrical vessel has an internal volume of 50 to 10,000 cm³.

In some embodiments, the light source has a wavelength emission from 250 to 500 nm.

In another exemplary embodiment, a method of carbon dioxide conversion is disclosed. The method includes bubbling carbon dioxide through an aqueous solution to form a gaseous water and carbon dioxide mixture, and feeding the gaseous water and carbon dioxide mixture into the aforementioned internal reflector photoreactor system. The method further includes irradiating the gaseous water and carbon dioxide mixture with visible light from the light source into the stainless-steel cylindrical vessel while reflecting the visible light from the reflector and producing a fuel from the gaseous water and carbon dioxide mixture.

In some embodiments, the feeding is done at a rate of 1 milliliter per minute (mL/min) to 500 mL/min.

In some embodiments, the method includes irradiating the gaseous water and carbon dioxide mixture for 0.5 to 5 hours.

In some embodiments, the fuel is selected from a group including hydrogen, one or more alcohols, and one or more hydrocarbons.

In some embodiments, the internal reflector photoreactor system produces 1.4 to 1.8 times more fuel than that of a photoreactor system without the reflector.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of the present disclosure (including alternatives and/or variations thereof) and many of the attendant advantages thereof will be readily obtained as the same becomes better understood by reference to the following detailed description of the embodiments when considered in connection with the accompanying drawings, wherein:

FIG. 1A is a schematic block diagram depicting an internal reflector photoreactor system, according to certain embodiments;

FIG. 1B is a flow chart depicting a method of making a graphitic carbon nitride (g-C₃N₄) photocatalyst, according to certain embodiments;

FIG. 1C is a flow chart depicting a method of coating a mesh with the g-C₃N₄ photocatalyst, according to certain embodiments;

FIG. 1D is a flow chart depicting a method for conversion of carbon dioxide (CO₂) to a plurality of fuels, according to certain embodiments;

FIG. 2 is a graph depicting X-ray diffraction (XRD) patterns of a graphitic carbon nitride (g-C₃N₄) photocatalyst, according to certain embodiments;

FIG. 3A is a field emission scanning electron microscopy (FE-SEM) image of the g-C₃N₄ photocatalyst, according to certain embodiments;

FIG. 3B is a high-resolution transmission electron microscopy (HR-TEM) image of the g-C₃N₄ photocatalyst, according to certain embodiments; and

FIG. 4 shows a comparative photocatalytic CO₂ conversion between the internal reflector photoreactor system with the g-C₃N₄ photocatalyst in the absence of a reflector and the internal reflector photoreactor system with the g-C₃N₄ photocatalyst in the presence of a reflector, according to certain embodiments.

### DETAILED DESCRIPTION

In the following description, it is understood that other embodiments may be utilized, and structural and operational changes may be made without departure from the scope of the present embodiments disclosed herein.

Reference will now be made in detail to specific embodiments or features, examples of which are illustrated in the accompanying drawings. Whenever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-verse without limiting the scope of the disclosure to the exact number or type of such elements unless set forth explicitly in the appended claims.

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

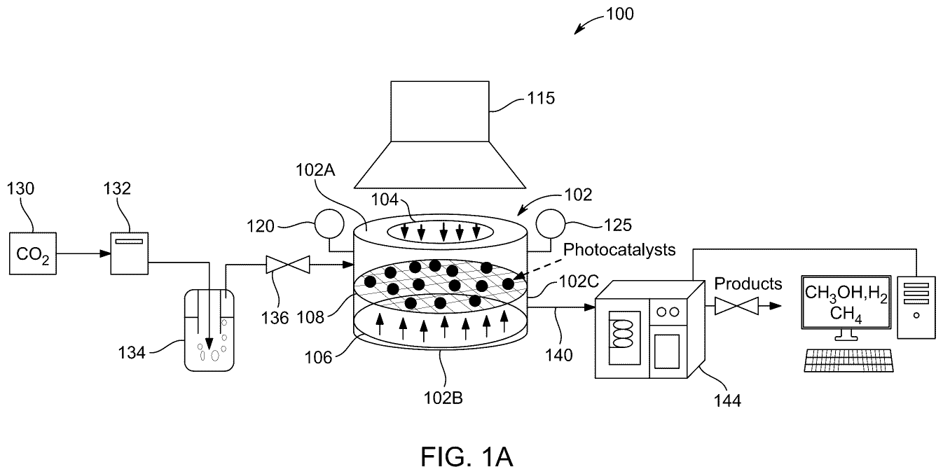

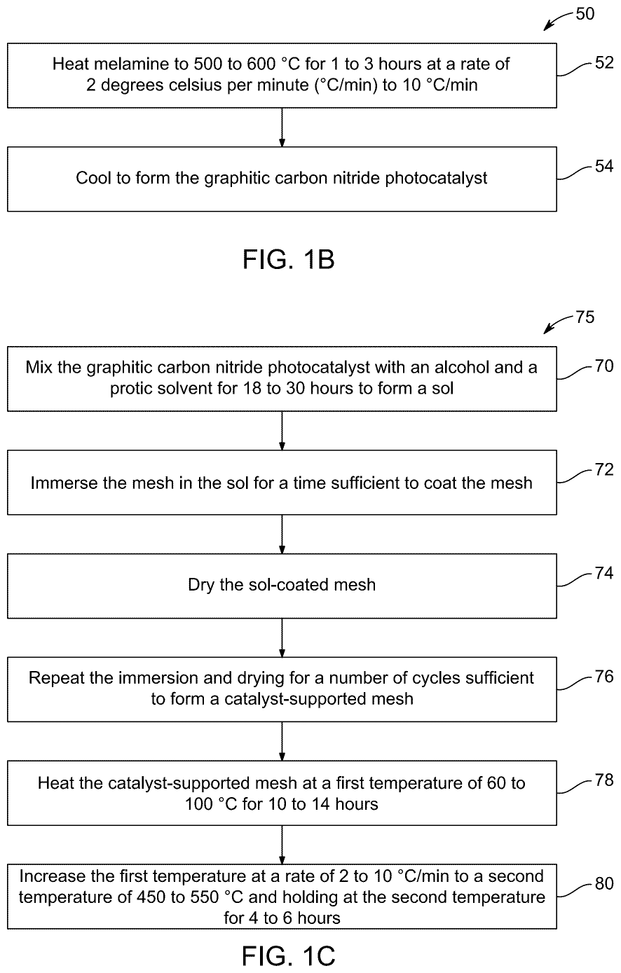

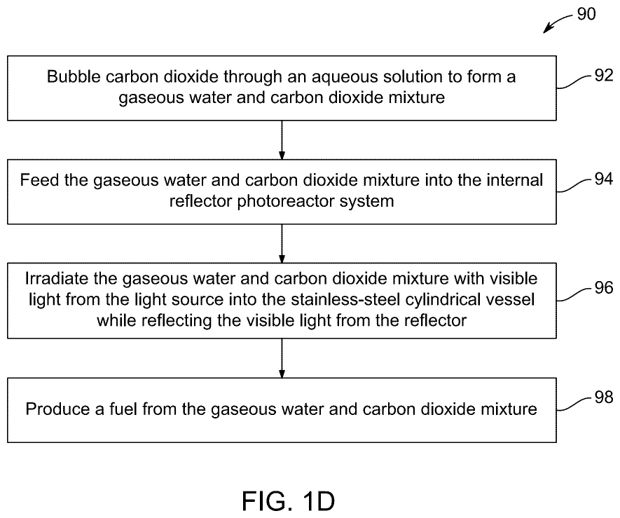

Referring to FIG. 1A, a schematic block diagram of an internal reflector photoreactor system 100 is illustrated, according to an embodiment of the present disclosure. In particular, an experimental setup for converting carbon dioxide (CO₂) to a plurality of green fuels is shown in FIG. 1A. The internal reflector photoreactor system 100 includes a stainless-steel cylindrical vessel 102. Stainless-steel is an alloy of iron that is resistant to rusting and corrosion. The stainless steel may further contain chromium, carbon, and nickel. The stainless-steel material has desired properties including, but not limited to, high tensile strength, high corrosion resistance, temperature resistant, easy machinability, low maintenance, and high durability. In some alternative embodiments, the stainless-steel cylindrical vessel 102 may not be made of stainless-steel and may be made of carbon steel, aluminum, titanium, copper, glass, quartz, ceramic materials, metal alloys, plastics, polymeric materials, carbon fibers, light weight carbon fibers, composite materials, a combination thereof, and/or any other material known in the art having desired properties. In some embodiments, the stainless-steel cylindrical vessel 102 may be optionally comprised of stainless-steel material and one or more materials having desired properties. In some embodiments, the stainless-steel cylindrical vessel 102 may have an internal volume of 50 cubic centimeters (cm³) to 10,000 cm³, preferably 60 to 6,000 cm³, preferably 70 to 4,000 cm³, preferably 80 to 2,000 cm³, preferably 90 to 500 cm³, more preferably 100 to 300 cm³, and yet more preferably about 160 cm³. In some embodiments, the stainless-steel cylindrical vessel 102 has a height of a vessel wall of 0.2 to 100 millimeters (mm), preferably 0.5 to 80 mm, preferably 1 to 60 mm, preferably 5 to 50 cm, and preferably 10 to 100 millimeters (mm). In some embodiments, the stainless-steel cylindrical vessel 102 may be cylindrical, rectangular, pyramidal, rectangular pyramidal, hexagonal, hexagonal pyramidal, a prism, and any other shape known in the art.

The stainless-steel cylindrical vessel 102 includes a window 104 defined on a top face 102A. The window 104 is a quartz window; however, in some embodiments, the window 104 may be manufactured using any other suitable see-through material. In some embodiments, the window 140 may cover an entire surface of the top face 102A. In some other embodiments, the window 140 may cover at least 50%, preferably at least 60%, preferably at least 70%, preferably at least 80%, preferably at least 90%, preferably at least 95%, more preferably at least 99%, and yet more preferably at least 99.5% of the entire area of the surface of the top face 102A thereby providing an equivalent unobstructed viewable area inside the stainless-steel cylindrical vessel. In an embodiment of the present disclosure, the stainless-steel cylindrical vessel 102 includes a reflector 106 configured to be positioned inside the stainless-steel cylindrical vessel 102 on a bottom face 102B. The reflector 106 is a surface used to redirect light towards a surface, object, and the like. The surface may be a mirror, a metal, and the like. In one embodiment, the reflector is a bottom wall of the stainless-steel cylindrical vessel that has been polished to provide light reflective properties. The reflector 106 is orientated towards the top face 102A of the stainless-steel cylindrical vessel 102. In some embodiments, the reflector 106 may be a planar reflector. In some embodiments, the reflector 106 may be a circular reflector, a spherical reflector, a conical reflector, an elliptical reflector, and the like. Preferably the reflector has a reflectivity of such that at least 95%, preferably 98%, 99% or 99.5% of incident light in the visible spectrum is reflected from its surface.

In some embodiments of the present disclosure, a vertical surface 102C of the stainless-steel cylindrical vessel 102 has one or more windows. In some other embodiments, the vertical surface 102C of the stainless-steel cylindrical vessel 102 may be a solid, continuous surface with an absence of one or more windows. The vertical surface 102C may be otherwise referred to as a circumferential face connecting the top face 102A and the bottom face 102B of the stainless-steel cylindrical vessel 102. The dimensional specification and construction of the one or more windows defined in the vertical surface 102C may be identical to the window 104 defined in the top face 102A. The one or more windows defined in the vertical surface 102C may be curved appropriately with the circumferential face. The one or more windows defined in the vertical surface 102C may be square, rectangular, circular, triangular, oval, and any other shape known in the art. Further, the one or more windows of the vertical surface 102C may be quartz windows, glass windows, or made of any other material that allows lights to pass through. In addition to the bottom face 102B, one or more internal surfaces of the stainless-steel cylindrical vessel 102 are reflective. In particular, one or more reflectors similar or identical to the reflector 106 may be positioned on the one or more internal surfaces. The internal surface of the stainless-steel cylindrical vessel 102 may be defined as an inside surface of the vertical surface 102C, the top face 102A, the bottom face 102B, or a combination thereof. The internal surface of the stainless-steel cylindrical vessel 102 may be comprised of reflective surfaces.

Further, the stainless-steel cylindrical vessel 102 includes a mesh 108 bisecting the stainless-steel cylindrical vessel 102 on a horizontal plane. In other words, the mesh 108 bisecting the stainless-steel cylindrical vessel 102 on the horizontal plane is positioned at an equal distance from an internal surface of the top face 102A and the bottom face 102B of the stainless-steel cylindrical vessel 102. In some embodiments, the mesh 108 has an area of at least 50%, preferably at least 60%, preferably at least 70%, preferably at least 80%, preferably at least 90%, more preferably at least 95%, and yet more preferably at least 99% the area of the top face 102A of the stainless-steel cylindrical vessel 102. In some embodiments, the stainless-steel cylindrical vessel 102 may include one or more of the mesh 108. In some embodiments, the mesh 108 bisecting the stainless-steel cylindrical vessel 102 on the horizontal plane may be mounted on an internal surface within the stainless-steel cylindrical vessel 102 along the height of the stainless-steel cylindrical vessel 102. In some embodiments, the mesh 108 bisecting the stainless-steel cylindrical vessel 102 on the horizontal plane may be mounted on a structure, such as a pole, pillar, and the like, arising from a bottom face 102B of the stainless-steel cylindrical vessel 102. In some embodiments, the mesh 108 bisecting the stainless-steel cylindrical vessel 102 on the horizontal plane may be positioned above and/or below the horizontal plane positioned at an equal distance from an internal surface of the top face 102A and the bottom face 102B of the stainless-steel cylindrical vessel 102. In some embodiments, the mesh 108 bisecting the stainless-steel cylindrical vessel 102 on the horizontal plane may be positioned in the top 10%, 20%, 30%, 40%, 50%, 60%, 70%, 80%, and 90% of the stainless-steel cylindrical vessel 102 where the percent is based on a total height of the stainless-steel cylindrical vessel 102. In a preferred embodiment, the mesh 108 bisecting the stainless-steel cylindrical vessel 102 on the horizontal plane is positioned at an equal distance from the top face 102A and the bottom face 102B of the stainless-steel cylindrical vessel 102.

In some embodiments, there may be one or more meshes 108 bisecting the stainless-steel cylindrical vessel 102 on one or more horizontal planes. In some embodiments, there may be one, two, three, four, five, six, seven, eight, nine, ten, and the like meshes 108 bisecting the stainless-steel cylindrical vessel 102 on horizontal planes. In some embodiments, the one or more meshes 108 may be stacked in one or more stories and/or levels in the stainless-steel cylindrical vessel 102. In some embodiments, the one or more stories may have a distance of 2 to 50 cm, preferably 4 to 40 cm, preferably 6 to 30 cm, preferably 8 to 20 cm, and preferably 10 to 15 cm separating the one or more stories of the one or more meshes 108 in the stainless-steel cylindrical vessel. In some preferred embodiments, the one or more stories of the one or more meshes 108 are positioned in an alternating, skewed, and/or off center manner with respect to one another such that the one or more meshes are not immediately in line with one another.

In some embodiments, the mesh 108 may be a solid mesh, a fabric mesh, a stainless-steel mesh, a mesh comprising one or more metals, a mesh comprising one or more metal-organic frameworks (MOFs), a combination thereof, and the like. In some embodiments, the mesh 108 has a wire mesh thickness of 7.188 mm (1 gauge), 6.668 mm (2 gauge), 6.19 mm (3 gauge), 5.723 mm (4 gauge), 5.258 mm (5 gauge), 4.877 mm (6 gauge), 4.496 mm (7 gauge), 4.115 mm (8 gauge), 3.767 mm (9 gauge), 3.429 mm (10 gauge), 3.061 mm (11 gauge), 2.68 mm (12 gauge), 2.324 mm (13 gauge), 2.032 mm (14 gauge), 1.829 mm (15 gauge), 1.588 mm (16 gauge), 1.372 mm (17 gauge), 1.207 mm (18 gauge), 1.041 mm (19 gauge), 0.884 mm (20 gauge), 0.805 mm (21 gauge), 0.726 mm (22 gauge), 0.635 mm (23 gauge), 0.584 mm (24 gauge), 0.518 mm (25 gauge), 0.46 mm (26 gauge), 0.439 mm (27 gauge), 0.411 mm (28 gauge), 0.381 mm (29 gauge), 0.356 mm (30 gauge), 0.335 mm (31 gauge), 0.325 mm (32 gauge), 0.3 mm (33 gauge), 0.264 mm (34 gauge), 0.241 mm (35 gauge), 0.229 mm (36 gauge), 0.216 mm (37 gauge), 0.203 mm (38 gauge), 0.191 mm (39 gauge), 0.178 mm (40 gauge), the like, and any other wire mesh thickness known in the art.

In some embodiments, the mesh 108 is coated with a graphitic carbon nitride photocatalyst (g-C₃N₄). In some embodiments, the mesh 108 is coated with 0.005 grams to 0.1 grams of graphitic carbon nitride photocatalyst per square centimeter of the mesh 108. The graphitic carbon nitride photocatalyst is in the form of two-dimensional aggregated nanosheets. The aggregated nanosheets have an irregular shape with ridges and valleys. The ridges and valleys have a length of 50 nanometers (nm) to 1000 nm. In some embodiments, the length of the ridges and the valleys may differ from the aforementioned length in order to better suit a different use case.

The internal reflector photoreactor system 100 further includes a light source 115. In some embodiments, the light source 115 is located above the stainless-steel cylindrical vessel 102. In particular, the light source 115 is positioned over the top face 102A of the stainless-steel cylindrical vessel 102, at a pre-determined distance from the top face 102A. In some embodiments, the light source 115 may include, but is not limited to, a solar lamp, an incandescent lamp, a fluorescent lamp, a light emitting diode (LED) lamp, and a solar light source. The light source 115 has a wavelength emission of 250 nm to 500 nm. In other words, the preferred wavelength emission of the light source 115 varies from 250 nm to 500 nm in a continuous manner. In some embodiments, the wavelength emission of the light source 115 may differ from the above stated values. In some embodiments, the internal reflector photoreactor system 100 may include one or more light sources configured to be positioned around an outer cylindrical surface (i.e., the vertical surface 102C) of the stainless-steel cylindrical vessel 102 at a distance from the outer cylindrical surface, on a vertical axis. Further, the stainless-steel cylindrical vessel 102 includes a pressure adjustor 120 and a temperature adjustor 125. In some embodiments, the pressure adjustor 120 may refer to a pressure relief valve and a pressure controller in conjunction with each other. As such, the pressure adjustor 120 is responsible for controlling and maintaining the pressure inside the stainless-steel cylindrical vessel 102. In case of high pressure, the pressure adjustor 120 may relieve the excess pressure using the pressure relief valve. Furthermore, the temperature adjustor 125 may include a heat source and a thermometer probe. The thermometer probe may check for the temperature inside the stainless-steel cylindrical vessel 102 and the heat source may provide external heating to the stainless-steel cylindrical vessel 102 in order to maintain a sufficient temperature inside the stainless-steel cylindrical vessel 102.

In addition, the internal reflector photoreactor system 100 includes a CO₂ source 130, a mass flow controller (MFC) 132, a water bubbler 134, and a feed 136. The MFC 132 is configured to regulate a flow of the CO₂ from the CO₂ source 130 headed towards the water bubbler 134. The water bubbler 134 is configured to prepare the feed 136. The feed 136 includes a gaseous water and CO₂ solution. The internal reflector photoreactor system 100 further includes an outlet 140, which is configured to release a product of the stainless-steel cylindrical vessel 102. A gas chromatography apparatus 144 is configured to be positioned at the outlet 140. The gas chromatography (GC) apparatus 144 is equipped with flame ionization detection (FID) and a thermal conductivity detector (TCD) in order to detect and report a quality of the product. The product may be referred to as fuel. The fuel is selected from a group including hydrogen, one or more alcohols, and one or more hydrocarbons. In some embodiments, the stainless-steel cylindrical vessel 102 may include a container to collect and/or store the fuel.

Referring to FIG. 1B, a flow chart of a method 50 of making a graphitic carbon nitride (g-C₃N₄) photocatalyst is described. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes heating melamine to 500 to 600° C. for 1 to 3 hours, at a rate of 2 degrees Celsius per minute (° C./min) to 10° C./min. This process is called pyrolysis. Pyrolysis is the process of thermochemical decomposition at elevated temperatures and in the absence of an oxidizing agent such as oxygen, hydrogen peroxide, and/or a halogen-containing gas (e.g., a chlorine-containing gas). In some embodiments, pyrolysis is performed in an inert gas (e.g., nitrogen, helium, neon, and/or argon), preferably nitrogen, and in a temperature range of 500 to 600° C., preferably 510 to 590° C., preferably 520 to 580° C., preferably 530 to 570° C., more preferably 540 and 560° C., and yet more preferably about 550° C. Pyrolysis of melamine preferably forms a solid g-C₃N₄. In some embodiments, pyrolysis may be performed by placing melamine in a ceramic crucible (e.g., an alumina crucible) or other form of containment and placing the contained melamine into a furnace, such as a tube furnace, and heating to the temperatures described above. The furnace is preferably equipped with a temperature control system, which may provide a heating rate of 2° C./min to up to 10° C./min, preferably 2° C./min to 9° C./min, preferably 3° C./min to 8° C./min, preferably 3° C./min to 7° C./min, and more preferably 4° C./min to 6° C./min, and yet more preferably about 5° C./min to an elevated temperature described above, and the powders are heated at such an elevated temperature (e.g., 550° C.) for 1 to 3 hours, preferably 1.5 to 2.5 hours, and more preferably about 2 hours. The furnace may also be equipped with a cooling accessory such as a cooling air stream system, or a liquid nitrogen stream system, which may provide a cooling rate of 2° C./min to up to 10° C./min, preferably 2° C./min to 9° C./min, preferably 3° C./min to 8° C./min, preferably 3° C./min to 7° C./min, more preferably 4° C./min to 6° C./min, and yet more preferably about 5° C./min.

In some embodiments, the g-C₃N₄ may be procured commercially or prepared by any conventional methods known in the art to prepare the g-C₃N₄ photocatalyst. In some embodiments, the g-C₃N₄ photocatalyst may be synthesized by thermal pyrolysis with other precursors, such as, but not limited to, dicyandiamide, cyanamide, urea, thiourea, and ammonium thiocyanate, alone and/or in combination with melamine.

At step 54, the method 50 includes cooling to form the graphitic carbon nitride photocatalyst. The g-C₃N₄ in the g-C₃N₄ photocatalyst may exist in different polymorphic forms such as α-C₃N₄, β-C₃N₄, cubic C₃N₄, pseudocubic C₃N₄, or mixtures thereof. The g-C₃N₄ prepared is in the form of nanosheets, but can be worked into powders, nanopowders, flakes, nanoflakes, films, nanofilms, fibers, nanofibers, foams, nanofoams, foils, nanofoils, micro foils, granules, nanogranules, insulated wires, honeycomb, dispersions, laminates, lumps, mesh, metallized films, non-woven fabrics, monofilament, rods, nanorods, single crystals, spheres, nanospheres, tubes, nanotubes, wires, and nanowires. In a preferred embodiment, the g-C₃N₄ photocatalyst is in the form of two-dimensional aggregated nanosheets. The aggregated nanosheets have an irregular shape with ridges and valleys, wherein the ridges and the valleys have a length of 50 to 1000 nanometers (nm), preferably 100 to 950 nm, preferably 150 to 900 nm, preferably 200 to 850 nm, preferably 250 to 800 nm, preferably 300 to 750 nm, preferably 350 to 700 nm, preferably 400 to 650 nm, preferably 450 to 600 nm, and preferably 500 to 550 nm. In some embodiments, a surface of the aggregated nanosheets have a smooth texture. In some embodiments, a surface of the aggregated nanosheets may be smooth, textured, the like, and a combination thereof.

Referring to FIG. 1C, a flow chart of a method 75 of coating the mesh with the graphitic carbon nitride photocatalyst is described. The order in which the method 75 is described is not intended to be construed as a limitation, and any number of the described method steps can be combined in any order to implement the method 75. Additionally, individual steps may be removed or skipped from the method 75 without departing from the spirit and scope of the present disclosure.

At step 70, the method 75 includes mixing the graphitic carbon nitride photocatalyst with an alcohol and a protic solvent for 18 to 30 hours to form a sol. A sol is a colloidal suspension made out of small solid particles dispersed in a continuous liquid medium. Suitable examples of protic solvents include, but are not limited to, acetic acid, n-butanol, isopropanol, n-propanol, ethanol, methanol, formic acid, water, ammonia, HF, and/or a combination thereof. The alcohol may be one or more selected from ethanol, butanol, methanol, propanol, ethylene glycol, diacetone alcohol, glycerol, cinnamic alcohol, isopropyl alcohol, the like, and/or a combination thereof. In a preferred embodiment, the g-C₃N₄ is mixed with acetic acid and isopropanol. The volume-by-volume ratio of the acetic acid and isopropanol is in the ratio of 1:5 to 5:1, preferably 1:4.5 to 4.5:1, preferably 1:4 to 4:1, preferably 1:3.5 to 3.5:1 preferably 1:3 to 3:1, preferably 1:2.5 to 2.5:1, preferably 1:2 to 2:1, and more preferably 1:1.5 to 1.5:1, and yet more preferably about 1:1.5 based on a total volume of the protic solvent and the alcohol. The mixing is carried out for a period sufficient to result in the formation of sol. In an embodiment, the mixing is carried out for 18 to 30 hours, preferably 20 to 28 hours, preferably 22 to 26 hours, and more preferably about 24 hours to form the sol. Mixing may encompass shaking, stirring, rotating, vibrating, sonication, and other means known in the art.

At step 72, the method 75 includes immersing the mesh in the sol for a time sufficient to coat the mesh. Before immersing the mesh in the sol, the mesh may be thoroughly cleaned with a suitable organic solvent, such as acetone, isopropanol, or preferably a mixture of both, to remove any organic residues/impurities affecting the coating process. The mesh may be dried at a temperature of 60 to 100° C., preferably 65 to 95° C., preferably 70 to 90° C., preferably 75 to 85, and more preferably about 80° C., for a time of 6 to 18 hours, preferably 8 to 14 hours, preferably 10 to 12 hours, and more preferably 12 hours, after it is cleaned In an embodiment, the mesh is immersed in the sol for 2 to 20 hours, preferably 4 to 18 hours, preferably 6 to 16 hours, preferably 8 to 14 hours, and preferably 10 to 12 hours to coat the mesh with the sol uniformly.

At step 74, the method 75 includes drying the sol-coated mesh. The sol-coated mesh is dried at a temperature of 60-100° C., preferably 70-90° C., and more preferably at about 80° C., for 6 to 15 hours, preferably 8 to 14 hours, preferably 10 to 12 hours, and more preferably about 12 hours, to remove any solvent molecules that interfere with the loading of the g-C₃N₄ photocatalyst onto the mesh.

At step 76, the method 75 includes repeating the immersing and drying for a number of cycles sufficient to form a catalyst-supported mesh. The process, as described in the earlier steps, may be repeated multiple times, preferably about 2 to 20 times, preferably 4 to 18 times, preferably 5 to 15 times, preferably 7 to 12 times, and preferably about 10 times until the desired amount of the g-C₃N₄ photocatalyst is loaded on the mesh.

At step 78, the method 75 includes heating the catalyst-supported mesh at a first temperature of 60 to 100° C., preferably 70 to 90° C., and more preferably at about 80° C., for 10 to 14 hours, preferably 8 to 12 hours, preferably 10 to 12 hours, and more preferably for about 12 hours.

At step 80, the method 75 includes increasing the first temperature at a rate of 2 to 10° C./min, preferably 3 to 9° C./min, preferably 3 to 8° C./min, preferably 4 to 7° C./min, preferably 4 to 6° C./min, and more preferably about 5° C./min to a second temperature of 450 to 550° C., preferably 475 to 525° C., and more preferably about 500° C. and holding at the second temperature for 4 to 6 hours, more preferably about 5 hours. The method of the present disclosure results in a mesh coated with 0.005 to 0.1 grams, preferably 0.01 to 0.09 grams, preferably 0.02 to 0.08 grams, preferably 0.03 to 0.07 grams, preferably 0.04 to 0.06 grams, and preferably about 0.05 grams of g-C₃N₄ photocatalyst per square centimeter of the mesh.

Referring to FIG. 1D, a flow chart of a method 90 for carbon dioxide (CO₂) conversion is described. The order in which the method 90 is described is not intended to be construed as a limitation, and any number of the described method steps can be combined in any order to implement the method 90. Additionally, individual steps may be removed or skipped from the method 90 without departing from the spirit and scope of the present disclosure.

At step 92, the method 90 includes bubbling carbon dioxide through an aqueous solution to form a gaseous water and CO₂ mixture. The CO₂ from the CO₂ source 132 is fed into the water bubbler 134, including the aqueous solution, to form the form the gaseous water and CO₂ mixture. It is preferred that the CO₂ is bubbled into the aqueous solution at a temperature typically in the range between room temperature and 60° C., preferably 50° C. or less, and more preferably in the range between about 20 to 45° C. In a preferred embodiment, the CO₂ is bubbled into the aqueous solution at atmospheric pressure, preferably 0.7 to 1.3 atmospheres (atm), preferably 0.8 to 1.2 atm, preferably 0.9 to 1.1 atm, and preferably about 1.0 atm. Although it is possible to increase the pressure to a higher level in order to improve the absorption capacity, it is preferable to carry out the bubbling process at atmospheric pressure to suppress the energy consumption from compression.

At step 94, the method 90 includes feeding the gaseous water and CO₂ mixture into the internal reflector photoreactor system 100. The feed 136, including the gaseous water and CO₂ mixture, is fed into the stainless-steel cylindrical vessel 102 of the internal reflector photoreactor system 100. In some embodiments, the feed 136 may optionally include hydrogen (H₂), water (H₂O), and/or methane (CH₄) alone or in combination with CO₂. In some embodiments, feeding the gaseous water and CO₂ mixture into the internal reflector photoreactor system 100 may be done in a continuous mode and in a batch mode. In some embodiments, in the batch mode, the feed 136 is held in the stainless-steel cylindrical vessel 102 of the internal reflector photoreactor system 100 for a time of 1 to 1000 minutes, preferably 10 to 250 minutes, and more preferably 30 to 60 minutes. In some embodiments, the feed 136 is continuously fed into the stainless-steel cylindrical vessel 102 of the internal reflector photoreactor system 100. In some other embodiments, the feed 136 is fed in batches into the stainless-steel cylindrical vessel 102 of the internal reflector photoreactor system 100. In some embodiments, the feed 136 is fed at a rate of 1 milliliter per minute (mL/min) to 500 mL/min, preferably 5 to 250 mL/min, preferably 7 to 150 mL/min, preferably 9 to 120 mL/min, more preferably 10 to 100 mL/min, and yet more preferably about 10 mL/min. In some embodiments, the rate of the feeding may vary as per the use case of a particular internal reflector photoreactor system 100.

At step 96, the method 90 includes irradiating the gaseous water and carbon dioxide mixture with visible light from the light source 115 into the stainless-steel cylindrical vessel 102 while reflecting the visible light from the reflector 106. The visible light from the light source 115 is configured to initiate a photocatalytic reaction. In some embodiments, the gaseous water and carbon dioxide mixture is irradiated for a time of 0.5 hours to 5.0 hours, preferably 0.6 to 4.0 hours, preferably 0.7 to 3.0 hours, preferably 0.8 to 2.0 hours, preferably 0.9 to 1.5 hours, and more preferably about 1.0 hour. In a preferred embodiment, the light source 115 is a 50-watt (W) solar lamp.

At step 98, the method 90 includes producing a fuel from the gaseous water and CO₂. In other words, the feed 136 is converted into the fuel after being processed through the internal reflector photoreactor system 100. In some embodiments, the fuel comprises hydrogen, one or more hydrocarbons, preferably methane, and one or more alcohols, preferably methanol.

In some embodiments, the internal reflector photoreactor system 100 produces 1.4 to 1.8 times, preferably 1.5 to 1.7 times, and more preferably about 1.6 times more fuel than that of a photoreactor system without a reflector.

### EXAMPLES

The disclosure will now be illustrated with working examples intended to demonstrate the working of the disclosure and not to restrictively imply any limitations on the scope of the present disclosure. The working examples depict an example of the method of the present disclosure.

The following examples demonstrate an internal reflector photoreactor system and a method for carbon dioxide (CO₂) conversion to green fuels using the internal reflector photoreactor system. The examples are provided solely for illustration and are not to be construed as limitations of the present disclosure, as many variations thereof are possible without departing from the spirit and scope of the present disclosure.

### Example 1: Preparation of Graphitic Carbon Nitride (g-C₃N₄) Photocatalyst

A bulk sample of g-C₃N₄ was fabricated by directly heating melamine in a semi-closed system. Typically, a covered crucible was utilized to hold 5 grams (g) of melamine. The crucible was then heated to 550° C. over 2 hours (h), with the temperature increasing at a rate of 5 degrees Celsius per minute (° C./min). After allowing the system to cool down naturally, a yellow powder was obtained and identified as g-C₃N₄. The g-C₃N₄ sol was then prepared by adding a mixture of 10 milliliters (mL) of acetic acid and 15 mL of isopropanol. This mixture was continuously agitated for 24 hours (h) to achieve a clear sol (g-C₃N₄ sol). To prepare the mesh for coating, a thorough cleaning process was carried out using acetone and isopropanol to eliminate any potential organic residues. Afterward, the mesh was dried at 80° C. for 12 hours, and its weight after drying was recorded. Subsequently, each mesh was immersed in the g-C₃N₄ sol obtained earlier for a specific period. Any excess sol within the mesh channels was removed using hot compressed air. This coating process was repeated as needed to attain the desired catalyst loading. To finalize the catalyst-supported meshes, as well as any remaining sol, they were dried at 80° C. for 12 hours, then subjected to a gradual heating process, increasing the temperature at a rate of 5° C. per minute until reaching 500° C., where they were held for 5 hours. The actual amount of catalyst loaded onto the mesh was determined by subtracting the weight of the uncoated mesh from that of the coated mesh. For comparison purposes, another photocatalyst was prepared using the same procedure.

### Example 2: Characterization of the Prepared Catalysts

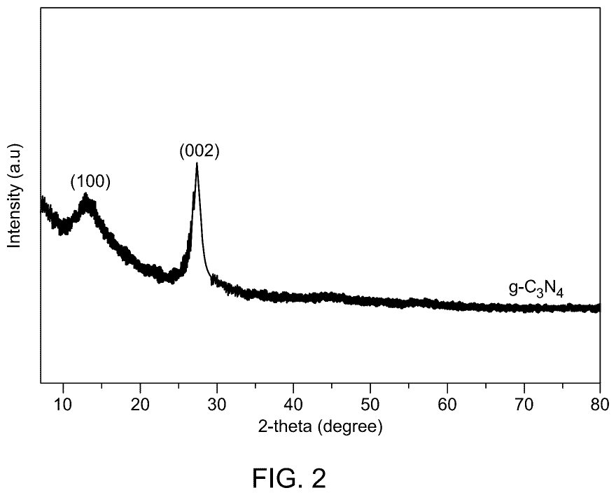

X-ray diffraction (XRD) analysis was conducted to investigate the crystal structures of the samples under examination. As shown in FIG. 2, the g-C₃N₄ material reveals two distinct diffraction peaks, each with a specific structural significance. The faint peak at 13 degrees is attributed to the structural arrangement of aromatic segments within the same plane, specifically corresponding to the (100) plane. The prominent peak at 27.4 degrees corresponds to the stacking of aromatic units between layers, denoted as the (002) plane.

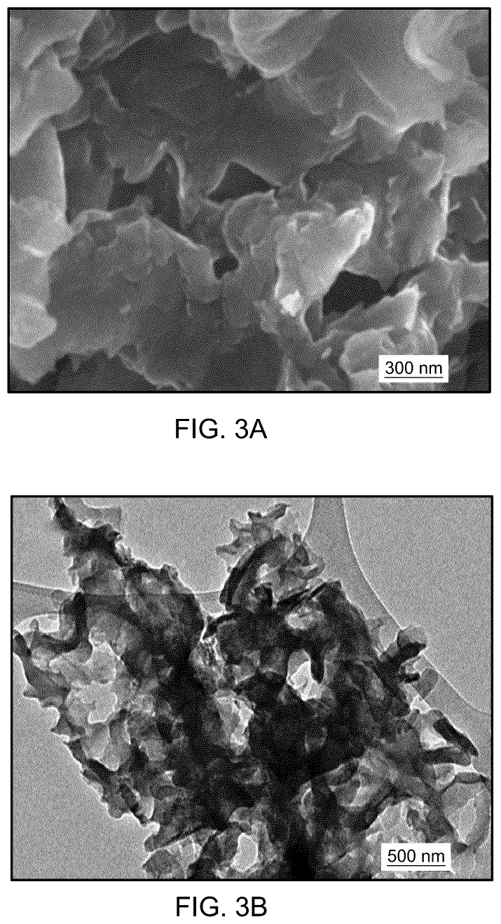

FIG. 3A illustrates the results of field emission scanning electron microscopy (FE-SEM) analysis of the g-C₃N₄ photocatalyst. The pure g-C₃N₄ photocatalyst is characterized by substantial aggregates composed of 2D nanosheets. These nanosheets exhibit an irregular morphology and vary in size, lacking uniform dimensions. Further, as shown in FIG. 3B, high-resolution transmission electron microscopy (HRTEM) analysis was conducted for insights into the morphology of the g-C₃N₄ photocatalyst. In this analysis, the g-C₃N₄ structure is revealed to be composed of a multitude of irregularly layered nanosheets, forming a distinct layered structure. Furthermore, these nanosheets exhibit relatively larger and smoother surfaces, making them well-suited as a substrate for various applications.

### Example 3: Testing of the Catalysts in the Internally Reflected Photoreactor

The coated mesh, with approximately 0.5 g of g-C₃N₄ photocatalyst, was placed at the center of the photoreactor. The light source used to activate the photocatalytic reactions was a 50-watt (W) solar lamp. The photoreactor was covered with aluminum foil to ensure that the reaction light only came through the quartz window. The compressed CO₂ flow was regulated by mass flow controllers (MFC) through the photoreactor chamber. The CO₂ was initially passed through water to carry moisture before entering the photoreactor. The experiments began with the lamp being turned on and gas being continuously fed into the photoreactor at a rate of 10 mL/min. The gaseous products were analyzed using gas chromatography (GC) equipped with flame ionization detection (FID) and thermal conductivity detection (TCD) detectors. Control experiments were conducted in the dark or without a catalyst under the same experimental conditions. In the absence of light irradiation or catalysts, no carbon-containing products were detected.

### Results & Discussion

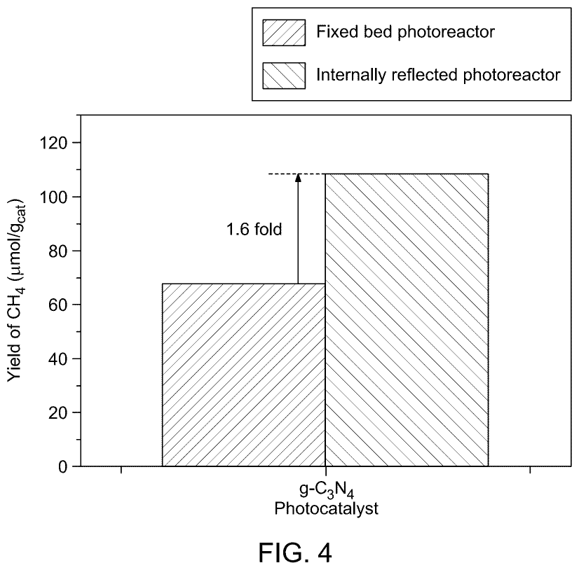

FIG. 4 compares the effectiveness of two photoreactor types, a fixed bed photoreactor with the g-C₃N₄ photocatalyst in the absence of a reflector and the internally reflected photoreactor with the g-C₃N₄ photocatalyst in the presence of a reflector or the internal reflector photoreactor system 100, in converting CO₂ into CH₄ when exposed to visible light. In this experiment, the internally reflected photoreactor, utilizing g-C₃N₄ as a catalyst, demonstrated greater catalytic performance to the same catalyst in the fixed bed photoreactor in the absence of a reflector. Replacing the fixed bed photoreactor with the internally reflected one increased CH₄ production yield from 67.7 micro-moles per gram of catalyst (μmole/g-cat) to 108.4 mole/g-cat. Specifically, when using the g-C₃N₄ photocatalyst in combination with a reflector, the yield rate of the internally reflected photoreactor was recorded to be 1.6 times higher than that of the fixed bed photoreactor. This difference can be attributed to the variation in the accessible light energy for CO₂ reduction. The fixed bed photoreactor has a lower light intensity, unlike the internally reflected photoreactor that employs a reflector to enhance light irradiation, thereby contributing to the increased CO₂ conversion and yield rates. The diminished yield rate in the fixed bed photoreactor is primarily a result of inadequate light exposure.

Aspects of the present disclosure are directed towards the sustainable conversion of CO₂ to using the internal reflector photoreactor system, and structured hierarchical photocatalysts were developed. Integrated photoreactors with a reflector provide higher photon flux for dynamic CO₂ conversion. The photocatalysts combined with a metal-organic framework (MOF) offer unique properties to synergize charge recombination rates and redox potentials. The g-C₃N₄ photocatalyst was modified with a MOF for a Z-scheme heterojunction system. Enhanced efficiency of CO₂ conversion was obtained in a solar photoreactor with green methanol production and other hydrocarbons. The internally reflected enhanced design of the photoreactor improves the overall efficiency of the CO₂ conversion process by maximizing light absorption, resulting in higher conversion rates and lower energy requirements. The present disclosure promotes sustainability by using renewable energy sources, like sunlight, to drive the conversion process, further reducing the reliance on fossil fuels and decreasing the carbon footprint associated with energy production. The present disclosure may find applications in a plurality of sectors, including, but not limited to, clean energy production, carbon capture and utilization, and sustainable fuel production. Further, the method and system disclosed in the present disclosure may be employed in industrial settings, power plants, and other facilities with CO₂ emissions.

Numerous modifications and variations of the present disclosure are possible in light of the above teachings. It is therefore to be understood that within the scope of the appended claims, the disclosure may be practiced otherwise than as specifically described herein.

1: An internal reflector photoreactor system, comprising:
a stainless-steel cylindrical vessel,
wherein the stainless-steel cylindrical vessel has a window on a top face,
wherein the stainless-steel cylindrical vessel has a reflector inside the stainless-steel cylindrical vessel on a bottom face orientated towards the top face,
wherein the stainless-steel cylindrical vessel has a mesh bisecting the stainless-steel cylindrical vessel on a horizontal plane,
wherein the mesh is coated with a graphitic carbon nitride photocatalyst,
a light source,
wherein the light source is located above the stainless-steel cylindrical vessel.

2: The internal reflector photoreactor system of claim 1, wherein the window is a quartz window.

3: The internal reflector photoreactor system of claim 1, wherein the reflector is a planar reflector.

4: The internal reflector photoreactor system of claim 1, wherein in addition to the bottom face, one or more internal surfaces of the stainless-steel cylindrical vessel are reflective.

5: The internal reflector photoreactor system of claim 1, wherein a vertical surface of the stainless-steel cylindrical vessel has one or more windows.

6: The internal reflector photoreactor system of claim 1, wherein the mesh bisecting the stainless-steel cylindrical vessel on the horizontal plane is at an equal distance from an internal surface of the top face and the bottom face.

7: The internal reflector photoreactor system of claim 1, wherein the graphitic carbon nitride photocatalyst is in the form of two-dimensional aggregated nanosheets.

8: The internal reflector photoreactor system of claim 7, wherein the aggregated nanosheets have an irregular shape with ridges and valleys, wherein the ridges and the valleys have a length of 50 to 1000 nanometers (nm).

9: The internal reflector photoreactor system of claim 1, wherein the graphitic carbon nitride photocatalyst is made by a process, comprising:
heating melamine to 500 to 600° C. for 1 to 3 hours at a rate of 2 degrees Celsius per minute (° C./min) to 10° C./min; and
cooling to form the graphitic carbon nitride photocatalyst.

10: The internal reflector photoreactor system of claim 1, wherein the mesh is coated with the graphitic carbon nitride photocatalyst by a process, comprising:
mixing the graphitic carbon nitride photocatalyst with an alcohol and a protic solvent for 18 to 30 hours to form a sol;
immersing the mesh in the sol for a time sufficient to coat the mesh;
drying the sol-coated mesh;
repeating the immersing and drying for a number of cycles sufficient to form a catalyst-supported mesh;
heating the catalyst-supported mesh at a first temperature of 60 to 100° C. for 10 to 14 hours; and
increasing the first temperature at a rate of 2 to 10° C./min to a second temperature of 450 to 550° C. and holding at the second temperature for 4 to 6 hours.

11: The internal reflector photoreactor system of claim 1, wherein the mesh is coated with 0.005 to 0.1 grams of graphitic carbon nitride photocatalyst per square centimeter of the mesh.

12: The internal reflector photoreactor system of claim 1, wherein the stainless-steel cylindrical vessel has a pressure adjustor.

13: The internal reflector photoreactor system of claim 1, wherein the stainless-steel cylindrical vessel has a temperature adjustor.

14: The internal reflector photoreactor system of claim 1, wherein the stainless-steel cylindrical vessel has an internal volume of 50 to 10,000 cm³.

15: The internal reflector photoreactor system of claim 1, wherein the light source has a wavelength emission from 250 to 500 nm.

16: A method of carbon dioxide conversion, comprising:
bubbling carbon dioxide through an aqueous solution to form a gaseous water and carbon dioxide mixture;
feeding the gaseous water and carbon dioxide mixture into the internal reflector photoreactor system of claim 1;
irradiating the gaseous water and carbon dioxide mixture with visible light from the light source into the stainless-steel cylindrical vessel while reflecting the visible light from the reflector; and
producing a fuel from the gaseous water and carbon dioxide mixture.

17: The method of claim 16, wherein the feeding is done at a rate of 1 milliliter per minute (mL/min) to 500 mL/min.

18: The method of claim 16, wherein the irradiating is done for 0.5 to 5 hours.

19: The method of claim 16, wherein the fuel is selected from a group comprising hydrogen, one or more alcohols, and one or more hydrocarbons.

20: The method of claim 16, wherein the internal reflector photoreactor system produces 1.4 to 1.8 times more fuel than that of a photoreactor system without the reflector.
